(19) United States
(12) Patent Application Publication
(10) Pub. No.: US 2019/0359169 A1
(43) Pub. Date: Nov. 28, 2019

(54) INTERIOR OBSERVATION FOR SEATBELT ADJUSTMENT

(71) Applicant: ZF Friedrichshafen AG, Friedrichshafen (DE)

(72) Inventors: Mark Schutera, Forchtenberg (DE); Tim Härle, Bad Waldsee (DE); Devi Alagarswamy, Ravensburg (DE)

(73) Assignee: ZF Friedrichshafen AG, Friedrichshafen (DE)

(21) Appl. No.: 16/419,476

(22) Filed: May 22, 2019

(30) Foreign Application Priority Data
May 22, 2018 (DE) 102018207977.3

(51) Int. Cl. B60R 22/195; B60R 21/015; B60W 10/30; B60W 30/08

(52) U.S. Cl. CPC B60R 22/195; B60R 21/01552; B60R 21/01542; B60R 21/0155; B60W 10/30; B60W 30/08; B60R 21/01538

(57) ABSTRACT

A driver assistance system for a vehicle may comprise a control unit that is configured to determine a state of a vehicle occupant via a neural network. The control unit may also activate a safety belt system for positioning and securing the vehicle occupant based on the identified state of the vehicle occupant.

### RELATED APPLICATIONS

This application claims the benefit and priority of German Patent Application DE 10 2018 207 977.3, filed May 22, 2018, which is incorporated by reference herein in its entirety.

### TECHNICAL FIELD

The present disclosure relates to the field of driver assistance systems, in particular a method and a device for securing a vehicle occupant in a vehicle with a safety belt device.

### BACKGROUND

Driver assistance systems include, for example, so-called attention assistants (also referred to as “driver state detection” or “drowsiness detection”). Such attention assistants comprise sensor systems for monitoring the driver, which follow the movements and the eyes of the driver, and thus detect drowsiness or distraction, and output a warning if appropriate.

Driver assistance systems that monitor the vehicle interior are known from the prior art. To provide the person responsible for driving with an overview the vehicle interior, there are one or more cameras in such systems, which monitor the interior. A system for monitoring a vehicle interior based on infrared rays is known from the German patent application DE 4 406 906 A1.

Furthermore, it is known from the prior art to provide a three-point belt system for a vehicle seat with numerous belt tensioners, in order to increase the safety of the occupants. The belt tensioning function ensures that a safety belt of a vehicle occupant that is buckled in is tensioned by a tensioning procedure if a collision is anticipated. The belt tensioners are configured such the belt is tightened around the body of the occupant on impact, without play, in order that the occupant can participate as quickly as possible in the deceleration of the vehicle, and the kinetic energy of the occupant is reduced quickly. For this, a coil, by means of which the safety belt can be rolled in and out, is rolled in slightly, by means of which the safety belt is tensioned. As a result, the slack in the belt that may occur in the event of an accident is reduced, such that a restraining function of the safety belt with respect to the vehicle occupants that are buckled in can be implemented.

The conventional pyrotechnical linear tensioners used in vehicles build up a force of 2-2.5 kN within a short time of 5-12 milliseconds in a cylinder-piston unit, with which the belt is retracted in order to eliminate slack. The piston is restrained at the end of the tensioning path, in order to restrain the occupants or to release the belt counter to the resistance of a force-limiting device, if such is present, in the subsequent, passive retention phase in which the occupant experiences a forward displacement.

A method and a belt tensioning system for restraining occupants of a vehicle when colliding with an obstacle is known from DE 10 2006 061 427 A1. The method provides that a potential accident is first identified by sensors, and then no later than a first contact of the vehicle with the obstacle, or upon exceeding a threshold for a vehicle deceleration, a force acting in the direction of impact is applied to the occupant. The force is introduced through a tensioning of the seat belt in a safety belt system at both ends, in that it is tensioned from both ends with a force of at least 2,000-4,500 N, and this force is maintained along a displacement path of the occupant over a restraining phase of at least 20 m/sec. An integrated belt tensioning system for tensioning a seat belt from both ends comprises two tensioners sharing a working chamber.

A safety belt system normally comprises a belt that forms a seat belt between the fitting at the end of the belt and the belt buckle, which is redirected at the buckle insert and guided to a redirecting device of a belt retractor located at the height of the shoulder of an occupant, and forms the shoulder belt in the region between the buckle and the redirecting device. The introduction of greater forces via a tensioning of the shoulder belt, e.g. by tensioning in the region of the belt retractor or at the belt buckle, reaches limits due to the limits with which an occupant can be subjected to such loads in the chest area.

U.S. Pat. No. 6,728,616 discloses a device for reducing the risk of injury to a vehicle occupant during an accident. The device comprises a means for varying the tension of a safety belt, based on the weight of the occupant and the speed of the vehicle. The weight of the occupant is determined via pressure sensors.

Based on this, the present disclosure describes a driver assistance system that further increases safety in the vehicle, and by means of which it is possible to reduce the loads to the occupants.

### BRIEF DESCRIPTION OF THE DRAWINGS

FIG. 1 shows a schematic top view of a vehicle, which is equipped with a driver assistance system according to the invention.

FIG. 2 shows a block diagram, schematically illustrating the configuration of a driver assistance system according to an exemplary embodiment of the present invention.

FIG. 3 shows a block diagram of an exemplary configuration of a control device.

FIG. 4a shows a flow chart of a process for determining the state of a vehicle occupant through analysis of one or more camera images Img1-Img8, according to an exemplary embodiment.

FIG. 4b shows a flow chart of a process for determining the state of a vehicle occupant according to an alternative exemplary embodiment, in which a further neural network is provided for obtaining depth of field data from camera images.

FIG. 4c shows a flow chart of a process for determining the state of a vehicle occupant according to an alternative exemplary embodiment, in which a 3D model of the vehicle occupant is generated by correlating camera images.

FIG. 5 shows, by way of example, a process for correlating two camera images, in order to identify correlating pixels.

FIG. 6 shows an exemplary process for reconstructing the three dimensional position of a pixel by means of stereoscopic technologies.

FIG. 7 shows a schematic illustration of a neural network.

FIG. 8 shows an exemplary output of the neural network.

FIG. 9 shows a safety belt system according to the invention.

FIG. 10 shows an exemplary qualitative heuristic for a safety belt routine.

FIG. 11 shows a collision detection according to the present invention.

FIG. 12 shows an exemplary qualitative heuristic for a safety belt routine in which the belt parameters are adapted taking into account a predicted deceleration that the driver would experience in a collision.

### DETAILED DESCRIPTION

According to the exemplary embodiments described below, a driver assistance system for a vehicle is created that comprises a control unit that is configured to determine a state of a vehicle occupant by means of a neural network, and activate a safety belt system for positioning or securing the vehicle occupants based on the identified state of the vehicle occupant(s).

If the occupant is leaning forward, such that he would not be optimally protected by an air bag in the event of an accident, he may then pulled back into a normal sitting position by tensioning the safety belt system, and restrained there. By way of example, the vehicle may skid prior to an accident, before the collision. As a result, the occupants of the vehicle are displaced, e.g. to the side, toward the windshield, or B-pillar of the vehicle, resulting in an increased risk of injury.

The control unit may be a control device, for example (electronic control unit, ECU, or electronic control module, ECM), which comprises a processor or the like. The control unit can be the control unit for an on-board computer in a motor vehicle, for example, and can assume, in addition to the generation of a 3D model of a vehicle occupant, other functions in the motor vehicle. The control unit can also be a component, dedicated for generating a virtual image of the vehicle interior.

The processor may be a control unit, e.g. a central processing unit (CPU), that executes program instructions.

According to one exemplary embodiment, the control unit is configured to identify a predefined driving situation, and to activate the safety belt system for positioning or securing the vehicle occupants when the predefined driving situation has been identified. By restraining the occupants prior to an accident, the occupants can be retained in an optimized position, in particular prior to a collision, a braking procedure, or skidding, such that the risk of injury to the occupants is reduced, and moreover, the vehicle driver is brought into a position in which he can react better to the critical situation, and potentially contribute to a stabilization of the vehicle.

The control unit may be configured to identify parameters of a predefined driving situation, and activate the safety belt system for positioning or securing the vehicle occupants based on these parameters. The control unit is configured to activate a safety belt system, for example. In particular, the control unit is configured to activate the safety belt system based on the detection of an impending collision, depending on the posture and weight of the vehicle occupant.

The safety belt system may be composed of numerous units that are activated independently of one another. By way of example, the safety belt system can comprise one or more belt tensioners. Alternatively or additionally, the safety belt system can comprise a controllable belt lock.

The control unit may also be configured to determine the state of the vehicle occupant by the analysis of one or more camera images from one or more vehicle interior cameras by the neural network. The one or more vehicle interior cameras can be black-and-white or color cameras, stereo cameras, or time-of-flight cameras. The cameras preferably have wide-angle lenses. The cameras can be positioned such that every location in the vehicle interior lies within the viewing range of at least one camera. Typical postures of the vehicle guests can be taken into account when installing the cameras, such that people do not block the view, or only block it to a minimal extent. The camera images are composed, e.g., of numerous pixels, each of which defines a gray value, a color value, or a datum regarding depth of field.

Additionally or alternatively, the control unit can be configured to generate a 3D model of the vehicle occupant based on camera images of one or more vehicle interior cameras, and to determine the state of the vehicle occupant through the analysis of the 3D model by the neural network. The control unit can also be configured to identify common features of a vehicle occupant in numerous camera images in order to generate a 3D model of the vehicle occupant. The identification of common features of a vehicle occupant can take place, for example, by correlating camera images with one another. A common feature can be a correlated pixel or group of pixels, or it can be certain structural or color patterns in the camera images. By way of example, camera images can be correlated with one another in order to identify correlating pixels or features, wherein the person skilled in the art can draw on appropriate image correlation methods that are known to him, e.g. methods such as those described by Olivier Faugeras et al. in the research report, “Real-time correlation-based stereo: algorithm, implementations and applications,” RR-2013, INRIA 1993. By way of example, two camera images can be correlated with one another. In order to increase the precision of the reconstruction, numerous camera images can be correlated with one another.

The control unit may be configured to reconstruct the model of the vehicle occupant from current camera images by means of stereoscopic techniques. As such, the generation of a 3D model can comprise a reconstruction of the three dimensional position of a vehicle occupant, e.g. a pixel or feature, by means of stereoscopic techniques. The 3D model of the vehicle occupant obtained in this manner can be generated, for example, as a collection of the three dimensional coordinates of all of the pixels identified in the correlation process. In addition, this collection of three dimensional points can also be approximated by planes, in order to obtain a 3D model with surfaces.

The state of the vehicle occupant can be defined, for example, by the posture of the vehicle occupant and the weight of the vehicle occupant. The control unit is configured, for example, to determine a posture and a weight of a vehicle occupant, and to activate the safety belt system on the basis of the posture and the weight of the vehicle occupant. The posture and weight of an occupant can be determined in particular by an image analysis of camera images from the vehicle interior cameras. In particular, the control unit can be configured to generate a 3D model of a vehicle occupant through evaluating camera images from one or more interior cameras or by correlating camera images from numerous vehicle interior cameras, which allows for conclusions to be drawn regarding the posture and weight. Posture refers herein to the body and head positions of the vehicle occupant, for example. Moreover, conclusions can also be drawn regarding the posture of the vehicle occupant, e.g. the line of vision and the position of the wrists of the occupant.

The control unit may also be configured to generate the model of the vehicle occupant taking depth of field data into account, provided by at least one of the cameras. Such depth of field data is provided, for example, by stereoscopic cameras or time-of-flight cameras. Such cameras provide depth of field data for individual pixels, which can be drawn on in conjunction with the pixel coordinates for generating the model.

According to some embodiments, the safety belt system according to the invention is provided such that, after tensioning the belt tensioners, a controllable belt lock retains the occupants in a retracted position.

The exemplary embodiments described in greater detail below also relate to a method for a driver assistance system in which a state of a vehicle occupant (Ins) is determined by means of a neural network, and safety belt system is activated for positioning or securing a vehicle occupant (Ins) based on the detected state of the vehicle occupant.

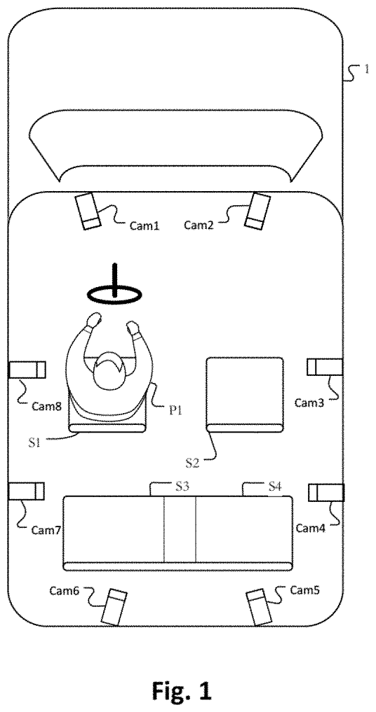

Now referring to the figures, FIG. 1 shows a schematic top view of a vehicle 1, which is equipped with an interior monitoring system. The interior monitoring system comprises an exemplary arrangement of interior cameras Cam1-Cam8. Two interior cameras Cam1, Cam2 are located in the front of the vehicle interior 2, two cameras Cam3, Cam4 are located on the right side of the vehicle interior 2, two interior cameras Cam5, Cam6 are located at the back, and two interior cameras Cam7, Cam8 are located on the left side of the vehicle interior 2. Each of the interior cameras Cam1-Cam8 records a portion of the interior 2 of the vehicle 1. The exemplary equipping of the vehicle with interior cameras is configured such that the interior cameras Cam1-Cam8 have the entire interior of the vehicle in view, in particular the vehicle occupants, even when there are numerous occupants. The cameras Cam1-Cam8 can be black-and-white or color cameras with wide-angle lenses, for example.

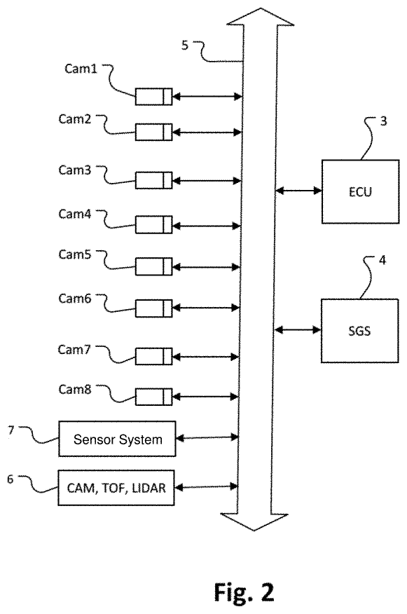

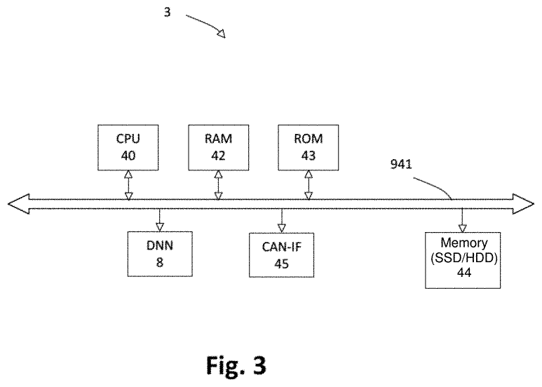

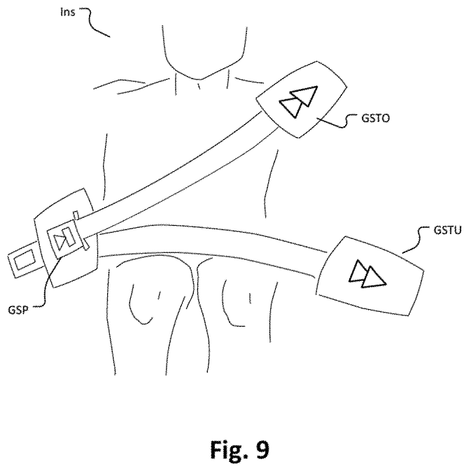

FIG. 2 schematically shows a block diagram of an exemplary driver assistance system. In addition to the interior cameras Cam1-Cam8, the driver assistance system comprises a control unit (ECU), a safety belt system 4 (SBS) and one or more environment sensors 6 (CAM, TOF, LIDAR). The images recorded by the various vehicle interior cameras Cam1-Cam8 are transferred via a communication system 5 (e.g. a CAN bus or LIN bus) to the control unit 3 for processing in the control unit 3. The control unit 3, which is shown in FIG. 3 and described in greater detail in reference thereto, is configured to continuously receive the image data of the vehicle interior cameras Cam1-Cam8, and subject them to an image processing, in order to derive a state of one or more of the vehicle occupants (e.g. weight and posture), and to control the safety belt system 4 based thereon. The safety belt system 4 is configured to secure an occupant sitting in a vehicle seat during the drive, and in particular in the event of a critical driving situation, e.g. an impending collision. The safety belt system 4 is shown in FIG. 9, and described in greater detail in reference thereto.

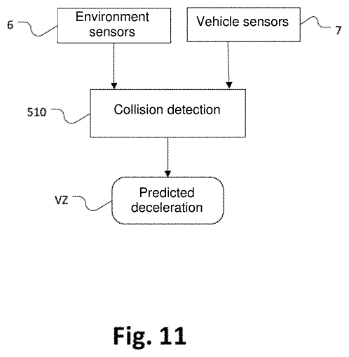

The environment sensors 6 are configured to record the environment of the vehicle, wherein the environment sensors 6 are mounted on the vehicle, and record objects or states in the environment of the vehicle. These include cameras, radar sensors, lidar sensors, ultrasound sensors, etc. in particular. The recorded sensor data from the environment sensors 6 is transferred via the vehicle communication network 5 to the control unit 3, in which it is analyzed with regard to the presence of a critical driving situation, as is described below in reference to FIG. 11.

Vehicle sensors 7 are preferably sensors that record a state of the vehicle or a state of vehicle components, in particular their state of movement. The sensors can comprise a vehicle speed sensor, a yaw rate sensor, an acceleration sensor, a steering wheel angle sensor, a vehicle load sensor, temperature sensors, pressure sensors, etc. By way of example, sensors can also be located along the brake lines in order to output signals indicating the brake fluid pressure at various locations along the hydraulic brake lines. Other sensors can be provided in the proximity of the wheels, which record the wheel speeds and the brake pressure applied to the wheel.

FIG. 3 shows a block diagram illustrating an exemplary configuration of a control unit. The control unit 3 can by a control device, for example (electronic control unit, ECU, or electronic control module, ECM). The control unit 3 comprises a processor 40. The processor 40 can be a computing unit, for example, such as a central processing unit (CPU), which executes program instructions.

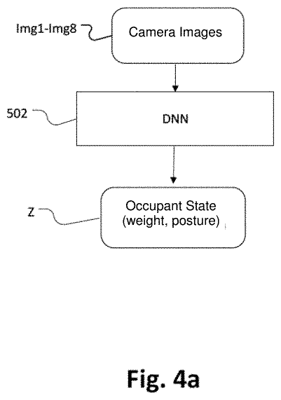

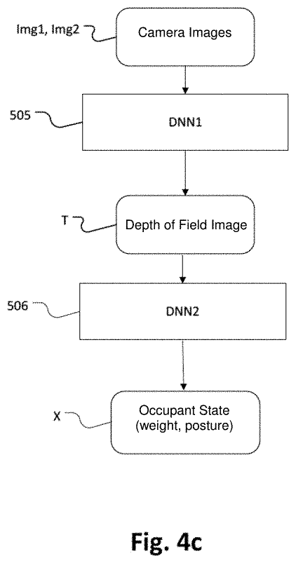

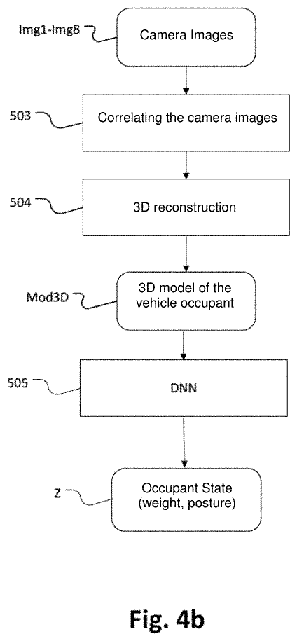

The processor 40 in the control unit 3 is configured to continuously receive camera images from the vehicle interior cameras Cam1-Cam8, and execute image analyses. The processor 40 in the control unit 3 is also, or alternatively, configured to generate a 3D model of one or more vehicle occupants by correlating camera images, as is shown in FIG. 4c and described more comprehensively below. The camera images, or the generated 3D model of the vehicle occupants are then fed to a neural network module 8, which enables a classification of the state (e.g. posture and weight) of a vehicle occupant in specific groups. The processor 40 is also configured to activate passive safety systems, e.g. a safety belt system (4 in FIG. 2) based on the results of this status classification. The processor 3 also implements a collision detection, as is described below in reference to FIG. 11.

The control unit 3 also comprises a memory and an input/output interface. The memory can be composed of one or more non-volatile computer-readable media, and comprises at least one program storage region and a data storage region. The program storage region and the data storage region can comprise combinations of various types of memories, e.g. a read-only memory 43 (ROM), and a random access memory 42 (RAM) (e.g. dynamic RAM (“DRAM”), synchronous DRAM (“SDRAM”), etc.). The control unit for autonomous driving 18 can also comprise an external memory drive 44, e.g. an external hard disk drive (HDD), a flash memory drive, or a non-volatile solid state drive (SSD).

The control unit 3 also comprises a communication interface 45, via which the control unit can communicate with the vehicle communication network (5 in FIG. 2).

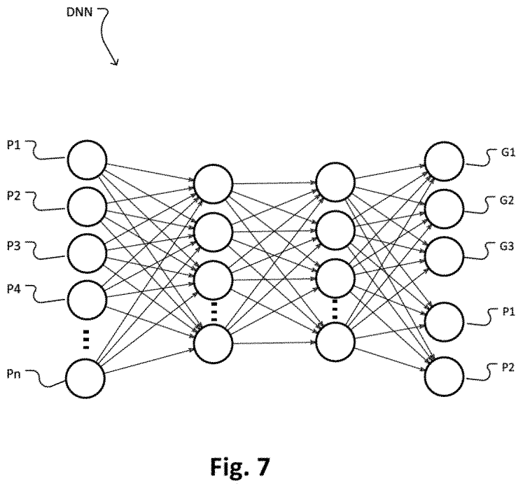

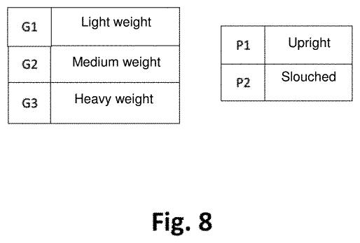

FIG. 4a shows a flow chart for a process for determining the state of a vehicle occupant through analysis of one or more camera images Img1-Img8 according to an exemplary embodiment. In step 502, camera images Img1-Img8 that are sent to the control unit from one or more of the interior cameras Cam1-Cam8, are sent to a deep neural network (DNN), which has been trained to recognize an occupant state Z from the camera images Img1-Img8. The neural network (see FIG. 7 and the associated description) then outputs the identified occupant state Z. The occupant state Z can be defined according to an heuristic model. By way of example, the occupant state Z can be defined by the weight and posture (pose) of the vehicle occupant, as is described in greater detail below in reference to FIG. 8.

FIG. 4b shows a flow chart for a process for determining the state of a vehicle occupant according to an alternative exemplary embodiment, in which a further neural network is provided for obtaining depth of field information from camera images. In step 505, two or more camera images Img1-Img8 supplied to the control unit from two or more interior cameras Cam1-Cam8 are sent to a deep neural network DNN1, which has been trained to obtain a depth of field image T from the camera images (505). In step 506, the depth of field image T is sent to a second deep neural network DNN2, which has been trained to identify an occupant state Z from the depth of field image T. The neural network DNN2 then outputs the identified occupant state Z. The occupant state Z can be defined according to an heuristic model. By way of example, the occupant state Z can be defined by weight and posture (pose), as is described in greater detail below in reference to FIG. 8.

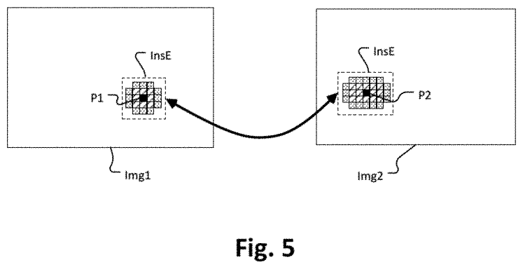

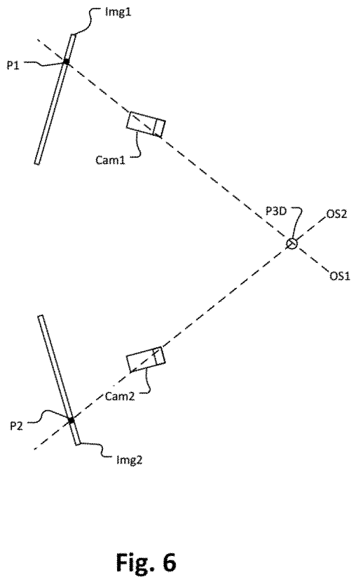

FIG. 4 shows a flow chart for a process for determining the state of a vehicle occupant according to an alternative exemplary embodiment, in which a 3D model of the vehicle occupant is generated through correlation of camera images. In step 503, two or more camera images Img1-Img8 recorded by two or more interior cameras (Cam1 to Cam8 in FIG. 1 and FIG. 2) are correlated with one another, in order to identify correlating pixels in the camera images Img1-Img8, as is described in greater detail below in reference to FIG. 5. In step 504, a 3D model Mod3D of the vehicle occupant is reconstructed from information obtained in step 502 regarding corresponding pixels, as is described in greater detail below in reference to FIG. 6. The 3D model Mod3D of the vehicle occupant is sent to a neural network in step 505, which has been trained to identify the occupant state from a 3D model Mod3D of the vehicle occupant. The neural network then outputs the identified occupant state Z. The occupant state Z can be defined according to an heuristic model. By way of example, the occupant state Z can be defined by the weight and posture (pose) of the vehicle occupant, as is described in greater detail below in reference to FIG. 8.

FIG. 5 shows, by way of example, a process for correlating two camera images, in order to identify correlating pixels. Two interior cameras, the positions and orientations of which in space are known, provide a first camera image Img1 and a second camera image Img2. These can be images Img1 and Img2, for example, from the two interior cameras Cam1 and Cam2 in FIG. 1. The positions and orientations of the two cameras differ, such that the two images Img1 and Img2 provide images of an exemplary object Obj from two different perspectives. Each of the camera images Img1 and Img2 are composed of individual pixels in accordance with the resolution and depth of color of the cameras. The two camera images Img1 and Img2 are correlated with one another, in order to identify correlating pixels, wherein the person skilled in the art can make use of appropriate image correlating process known to him for this, as already stated above. In the correlation process, it is detected that one element InsE (e.g. a pixel or group of pixels) of the vehicle occupant is recorded in both the image Img1 as well as image Img2, and that, for example, pixel P1 in image Img1 correlates to pixel P2 in image Img2. The position of the vehicle occupant element InsE in image Img1 differs from the position of the vehicle occupant element InsE in image Img2 due to the different camera positions and orientations. Likewise, the form of the image of the vehicle occupant element InsE also differs in the second camera image from the form of the image of the vehicle occupant element InsE in the first camera image due to the change in perspective. The position of the vehicle occupant element InsE or the pixels thereof, can be determined in three dimensional space, using stereoscopic technologies, from the different positions of the vehicle occupant element, for example, in image Img1 in comparison to pixel P2 in image Img2 (cf. FIG. 7, and the description below). The correlation process thus provides the positions of numerous pixels of a vehicle occupant in a vehicle interior in this manner, from which a 3D model of the vehicle occupant can be constructed.

FIG. 6 shows an exemplary process for reconstructing the three dimensional position of a pixel by means of stereoscopic technologies. A corresponding optical beam OS1 or OS2 is calculated for each pixel P1, P2 from the known positions and orientations of the two cameras Cam1 and Cam2, as well as from the likewise known positions and locations of the image planes of the camera images Img1 and Img2. The intersection of the two optical beams OS1 and OS2 provides the three dimensional position P3D of the pixel that is imaged as pixel P1 and P2 in the two camera images Img1 and Img2. In the above example from FIG. 7, two camera images are evaluated, by way of example, in order to determine the three dimensional position of two correlated pixels. In this manner, the images from individual pairs of cameras Cam1/Cam2, Cam3/Cam4, Cam5/Cam6, or Cam7/Cam8 can be correlated with one another in order to generate the 3D model. In order to increase the reconstruction precision, numerous camera images can be correlated with one another. If, for example, three or more camera images are correlated with one another, then a first camera image can be selected as the reference image, for example, in reference to which a disparity chart can be calculated for each of the other camera images. The disparity charts obtained in this manner are then combined in that the correlations with the best results are selected, for example. The model of the vehicle occupant obtained in this manner can be constructed, for example, as a collection of three dimensional coordinates of all of the pixels identified in the correlation process. This collection of three dimensional points can also be approximated by planes, to obtain a model with surfaces.

FIG. 7 shows a schematic image of a neural network according to the present invention. In a preferred exemplary embodiment, the control unit (cf. FIG. 3) implements at least one neural network (deep neural network, DNN). The neural network can be implemented, for example, as a hardware module (cf. 8 in FIG. 3). Alternatively, the neural network can also be implemented by means of software in a processor (40 in FIG. 3).

Neural networks, in particular convolutional neural networks (CNNs), enable a modeling of complex spatial relationships in image data, for example, and consequently a data driven status classification (weight and posture of a vehicle occupant). With a capable computer, both the vehicle behavior as well as the behavior of the occupant and the state of the occupant can be modeled, in order to derive predictions for actions by passive safety systems, e.g. belt tensioners and belt locks.

The properties and implementation of neural networks are known to the relevant experts. In particular, reference is made here to the comprehensive literature regarding the structure, types of networks, learning rules, and known applications of neural networks.

In the present case, image data from cameras Cam1-Cam8 are sent to the neural network. The neural network can receive filtered image data, or the pixels P1, . . . , Pn thereof as input, and process this in order to determine a driver's state as output, e.g. whether the vehicle occupant is in an upright position, output neuron P1, or in a slouched position, output neuron P2, and whether the vehicle occupant is light, output neuron G1, a medium weight, output neuron G2, or heavy, output neuron G3. The neural network can classify a recorded vehicle occupant, for example, as “occupant in upright position,” or “occupant in slouched posture,” or as “light occupant,” “medium weight occupant,” or “heavy occupant.”

The neural network can contain a neural network constructed according to a multi-level (or “deep”) model. A neural multi-level network model can contain an input level, numerous inner layers, and an output layer. A neural multi-level network model can also contain a loss level. For the classification of sensor data (e.g. a camera image), values in the sensor data (e.g. pixel values) are assigned to input nodes and then fed through the numerous inner layers of the neural network. The numerous inner layers can execute a series of non-linear transformations. After the transformations, an output node produces a value corresponding to the classification (e.g. “upright” or “slouched”) that is deduced by the neural network.

The neural network is configured (“trained”) such that for certain known input values, the expected responses are obtained. If such a neural network has been trained, and its parameters have been set, the network is normally used as a type of black box, which also produces associated and appropriate output values for unfamiliar input values.

In this manner, the neural network can be trained to distinguish between desired classifications, e.g. “occupant in upright position,” or “occupant in slouched position,” “light occupant,” medium weight occupant,” and “heavy occupant,” based on camera images.

FIG. 8 shows an exemplary output of the neural network module 8. The neural network enables specific classification of a camera image from the interior cameras Cam1-Cam8 (FIG. 4a) or a 3D model of the vehicle occupant (FIG. 4b). The classification is based on a predefined heuristic model. In the example in FIG. 6, a distinction is made between the weight classifications G1, “light occupant,” (e.g. <65 kg), G2, “medium weight occupant,” (e.g. 65-80 kg), and G3, “heavy occupant,” (>80 kg), as well as between the posture classifications, P1, “occupant in upright position,” and P2, “occupant in slouched position.”

The status classifications listed herein are schematic and exemplary. Additionally or alternatively, other states can be defined, and would also be conceivable to draw conclusions regarding the behavior of the vehicle occupant from a camera image from the interior cameras Cam1-Cam8, or a 3D model of the vehicle occupant. By way of example, a line of vision, a wrist position, etc. could be derived from the image data, and classified by means of a neural network.

FIG. 9 shows a safety belt system according to the present invention. The safety belt system is based on the three-point belt, and secures a vehicle occupant Ins. This system is expanded with two belt tensioners on one side of the vehicle occupant, an upper belt tensioner GSPO and a lower belt tensioner GSPU, and a belt lock GSP above the buckle insert of the belt. The three units can be activated and actuated independently. The belt tensioners GSPO, GSPU are capable of retracting the belt with a defined tensile force, wherein the belt lock GSP is merely capable of holding the belt in position at the appropriate point.

According to the invention, the belt tensioners GSPO and GSPU are activated by the control unit (3 in FIG. 2), depending on the driving situation and the results of the status classification of the vehicle occupant, such that the safety belt is tensioned with an increased belt tensioning force. The torso of the vehicle occupant Ins is moved by the belt tensioning force counter to the direction of travel, toward the backrest of the vehicle seat.

The intention is to bring the occupant into an optimal position prior to a collision with a corresponding pulling direction and tensile force by the belt tensioner GST and using the belt lock GSP. The optimal position is defined herein as the position in which the passive safety system (airbag, etc.) assumes the optimal level of efficiency. It is assumed that this corresponds to the upright position of the occupant, wherein the belt is tensioned. If, for example, a passenger assumes a slouched position, he is then no longer in the position in which an optimal protection by the airbag is ensured, and his position can be corrected by tensioning the safety belt.

The optimal position is obtained more quickly as a result of the belt lock GSP, because the length of belt that is to be retracted between the upper belt tensioner GSTO and the belt lock GSP is decisive, and there is no need to retract the entire length of belt between the two belt tensioners.

A belt tensioner can be in the form of an electric motor, for example. In this case, a voltage that is higher than the nominal voltage of the electric motor can be supplied to the electric motor serving as a belt tensioner, in order to generate the increased belt tensioning force. Alternatively, a gearing ratio of the electric motor can be altered. In a further alternative embodiment, the increased belt tensioning force can be obtained by means of a mechanical or electrical energy store.

According to the invention, the control unit is configured to activate the belt tensioner in the safety belt system 4, and introduce defined forces when a critical driving situation has been identified, e.g. in the event of a predicted collision or a predicted emergency braking that may be triggered by a collision or an actuation of the brake pedal, and detection of an object with sensors that look ahead, or by the braking assistance.

The control unit 3 is also configured such that the state of a vehicle occupant determined by the image processing is incorporated into the control of the belt tensioner. As a result, the level of force can be increased for heavier occupants, and reduced for lighter occupants, in order to thus ensure not only optimal safety, but also maximum comfort for the occupant.

A heuristic is provided for the adapted user of the belt tensioner, for example, which defines a corresponding belt tensioning routine based on the posture and weight of the occupant, as well as a vehicle status/driving situation. Additionally or alternatively, this can be learned based on data, and thus optimized.

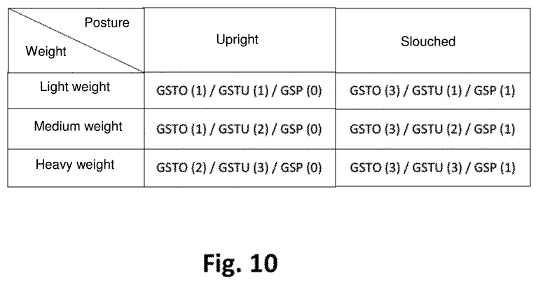

FIG. 10 shows an exemplary qualitative heuristic for a safety belt control with the intensity of the upper belt tensioner (GSTO) and the lower belt tensioner (GSTU), and the belt lock (GSP). The belt tensioners are set to intensities 0, 1, 2, or 3, which correspond to increasing levels of force, while the belt lock is set to intensities of 0 (no belt lock) or 1 (activated belt lock).

As can be seen from the table in FIG. 10, the safety belt system is activated with a light occupant in an upright position such that the intensities equal 1 for the GSTO, 1 for the GSTU, and 0 for the GSP. With a light occupant in a slouched position, the safety belt system is activated such that the intensities equal 3 for the GSTO, 1 for the GSTU, and 1 for the GSP. With a medium weight occupant in an upright position, the safety belt system is activated such that the intensities equal 1 for the GSTO, 2 for the GSTU, and 0 for the GSP. With a medium weight occupant in a slouched position, the safety belt system is activated such that the intensities equal 3 for the GSTO, 2 for the GSTU, and 1 for the GSP. With a heavy occupant in an upright position, the safety belt system is activated such that the intensities equal 2 for the GSTO, 3 for the GSTU, and 0 for the GSP. With a heavy occupant in a slouched position, the safety belt system is activated such that the intensities equal 3 for the GSTO, 3 for the GSTU, and 1 for the GSP.

In a preferred embodiment of the present invention, the belt parameters are also adapted taking a predicted deceleration into account, which the driver would experience in a collision or braking procedure. In order to anticipate the deceleration, a collision prediction is first carried out. The aim is to estimate, for example, the “point of no return,” at which point a collision can no longer be avoided, and impact is immanent. The deceleration strategy and the resulting decelerations are then derived on the basis of this “point of no return,” and the resulting impact speed.

FIG. 11 shows a schematic collision detection according to the present invention. The collision detection, which is implemented in the control unit (3 in FIG. 2) for example, receives data from environment sensors 6 and vehicle sensors 7 (cf. FIG. 2). In step 510, the control unit determines whether a collision or an abrupt braking procedure is about to take place or not, based on sensor data. In the event of an impending collision, parameters of the anticipated collision are predicted, e.g. a predicted deceleration VZ. A critical vehicle state is identified by means of the collision detection through the method according to the invention by monitoring vehicle accelerations, speeds, relative speeds, and the distance to a vehicle or object driving or standing in front of the vehicle, yaw angle, yaw rate, steering angle, and/or transverse acceleration, or an arbitrary combination of these parameters.

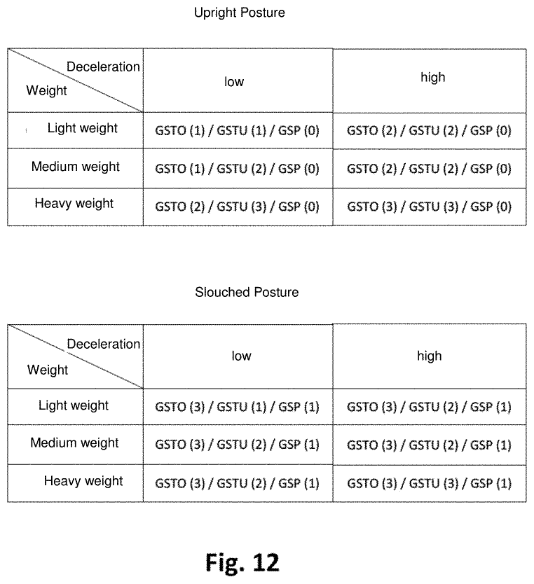

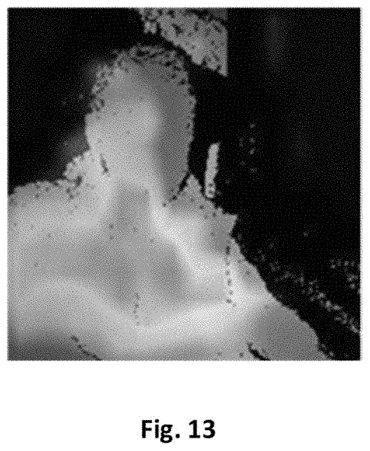

FIG. 12 shows an exemplary qualitative heuristic for a safety belt routine in which the belt parameters are adapted taking into account a predicted deceleration that the driver would experience in a collision.

The upper table in FIG. 12 shows an heuristic in the case of an upright position of the vehicle occupant. As can be seen from the table, with a light occupant and slight deceleration, the safety belt system is activated such that the intensities equal 1 for the GSTO, 1 for the GSTU, and 0 for the GSP. With a light occupant and higher deceleration, the safety belt system is activated such that the intensities equal 2 for the GSTO, 2 for the GSTU, and 0 for the GSP. With a medium weight occupant and slight deceleration, the safety belt system is activated such that the intensities equal 1 for the GSTO, 2 for the GSTU, and 0 for the GSP. With a medium weight occupant and higher decelerations, the safety belt system is activated such that the intensities equal 2 for the GSTO, 2 for the GSTU, and 0 for the GSP. With a heavy occupant and slight decelerations, the safety belt system is activated such that the intensities equal 2 for the GSTO, 3 for the GSTU, and 0 for the GSP. With a heavy occupant and higher decelerations, the safety belt system is activated such that the intensities equal 3 for the GSTO, 3 for the GSTU, and 0 for the GSP.

The lower table in FIG. 12 shows an heuristic in the case of a slouched posture of the vehicle occupant. As can be seen from the table, with a light occupant and slight decelerations, the safety belt system is activated such that the intensities equal 3 for the GSTO, 1 for the GSTU, and 1 for the GSP. With a light occupant and higher decelerations, the safety belt system is activated such that the intensities equal 3 for the GSTO, 2 for the GSTU, and 1 for the GSP. With a medium weight occupant and slight decelerations, the safety belt system is activated such that the intensities equal 3 for the GSTO, 2 for the GSTU, and 1 for the GSP. With a medium weight occupant and higher decelerations, the safety belt system is activated such that the intensities equal 3 for the GSTO, 2 for the GSTU, and 1 for the GSP. With a heavy occupant and slight decelerations, the safety belt system is activated such that the intensities equal 3 for the GSTO, 2 for the GSTU, and 1 for the GSP. With a heavy occupant and high decelerations, the safety belt system is activated such that the intensities equal 3 for the GSTO, 3 for the GSTU, and 1 for the GSP.

The use of a neural network for determining the driver state enables, for example, a determination of a so-called “attention map,” which indicates which parts of a vehicle occupant are particularly relevant for the detection of the occupant's state.

FIG. 13 shows an exemplary “attention map,” which illustrates the important properties for the weight classification with CNNs. The “attention map” indicates which parts of the input image are particularly important for determining the state of the driver. This improves the understanding and interpretation of the results and the functioning of the algorithm, and can also be used to optimize the cameras, camera positions, and camera orientations.

We claim:

1. A driver assistance system for a vehicle comprising:
a control unit; and
a safety belt system,
wherein the control unit is configured to determine a state of a vehicle occupant via a neural network, and
wherein the control unit is also configured to activate the safety belt system for at least one of positioning and securing the vehicle occupant based on the identified state of the vehicle occupant.

2. The driver assistance system according to claim 1, wherein the control unit is configured to identify a predefined driving situation, and wherein the control unit is configured to activate the safety belt system for positioning or securing the vehicle occupant when a predefined driving situation has been identified.

3. The driver assistance system according to claim 1, wherein the control unit is configured to identify parameters of a predefined driving situation, and wherein the control unit is configured to activate the safety belt system for positioning or securing the vehicle occupant based on these parameters.

4. The driver assistance system according to claim 1, wherein the control unit is configured to determine the state of the vehicle occupant through the analysis of one or more camera images from one or more vehicle interior cameras by the neural network.

5. The driver assistance system according to claim 1, wherein the state of the vehicle occupant is defined by the posture of the vehicle occupant and the weight of the vehicle occupant.

6. The driver assistance system according to claim 1, wherein the control unit is configured to generate a 3D model of the vehicle occupant based on the camera images from one or more vehicle interior cameras and to determine the state of the vehicle occupant through the analysis of the 3D model by the neural network.

7. The driver assistance system according to claim 1, wherein the safety belt system is composed of a plurality of units, and wherein each unit of the plurality of units is activated independently of the other units of the plurality of units.

8. The driver assistance system according to claim 1, wherein the safety belt system comprises one or more controllable belt tensioners.

9. The driver assistance system according to claim 1, wherein the safety belt system comprises a controllable belt lock.

10. A driver assistance system for a vehicle comprising:
a control unit,
wherein the control unit is configured to determine a state of a vehicle occupant via a neural network, and
wherein the control unit is also configured to activate a safety belt system for at securing the vehicle occupant based on the identified state of the vehicle occupant.

11. A method for a driver assistance system, the method comprising:
determine a state of a vehicle occupant via a neural network of a control unit, and
activating a safety belt system for at securing the vehicle occupant based on the identified state of the vehicle occupant.

12. The method of claim 11, wherein the control unit is configured to identify a predefined driving situation, and wherein the control unit is configured to activate the safety belt system for positioning or securing the vehicle occupant when a predefined driving situation has been identified.

13. The method of claim 11, wherein the control unit is configured to identify parameters of a predefined driving situation, and wherein the control unit is configured to activate the safety belt system for positioning or securing the vehicle occupant based on these parameters.

14. The method of claim 11, wherein the control unit is configured to determine the state of the vehicle occupant through the analysis of one or more camera images from one or more vehicle interior cameras by the neural network.

15. The method of claim 11, wherein the state of the vehicle occupant is defined by the posture of the vehicle occupant and the weight of the vehicle occupant.

16. The method of claim 11, wherein the control unit is configured to generate a 3D model of the vehicle occupant based on the camera images from one or more vehicle interior cameras and to determine the state of the vehicle occupant through the analysis of the 3D model by the neural network.

17. The method of claim 11, wherein the safety belt system is composed of a plurality of units, and wherein each unit of the plurality of units is activated independently of the other units of the plurality of units.

18. The method of claim 11, wherein the safety belt system comprises one or more controllable belt tensioners.

19. The method of claim 11, wherein the safety belt system comprises a controllable belt lock.

20. The method of claim 11, further comprising installing the control unit.
